(19) United States
(12) Patent Application Publication
(10) Pub. No.: US 2011/0102327 A1
(43) Pub. Date: May 5, 2011

(54) PHOTO ALBUM CONTROLLER

(75) Inventors: Sukeichi Miki, Nara (JP); Shinichi Miki, Nara (JP); Manabu Miki, Nara (JP); Hikaru Miki, Nara (JP)

(73) Assignee: VISIONARIST CO., LTD., Ikoma-shi, Nara (JP)

(21) Appl. No.: 13/000,617

(22) PCT Filed: Jun. 24, 2008
(86) PCT No.: PCT/JP2008/061493

§ 371 Date: Dec. 21, 2010

(51) Int. Cl. G06F 3/02; G06F 3/048; G06F 3/00; G09G 5/00

(52) U.S. Cl. 345/168; 715/780; 715/730; 345/156

(57) ABSTRACT

A photo album controller which can simultaneously display a high-quality image data and attribute information on separate screens and can easily display the image data or change the attribute information through a small number of input operations is provided.

The photo album controller 1 includes an image display screen 3 to display an image data 2, an attribute information display screen 5 to display the attribute information 4, and a remote controller 12 to control the display of the image data 2 and the change of the attribute information 4. The user can easily watch a high-quality image data 2 while visually recognizing a folder name which is changed by the user or a shooting date which is automatically changed through a small number of simple input operations. Moreover, the photo album controller 1 enables the user to watch not only the image data 2 and the attribute information 5 simply but also a detailed status and feedback, for example, when the image data 2 is taken as the sentence 36 by setting up the slide show using a third operation key group 123.

### TECHNICAL FIELD

The present invention relates to a photo album controller which can display image data and attribute information of the image data, easily display desired image data, and further change the attribute information easily.

### BACKGROUND TECHNIQUE

Recently, a spread of high-definition digital cameras and large-screen TVs (televisions) leads to an increase of users who watch image data taken by the digital camera on the large-screen TV. In accordance with the spread of the digital cameras, the user holds large amounts of image data. The user adds arbitrary attribute information to the large amounts of image data to classify them by using a personal computer. However, the user who does not have the personal computer or is not good at a computer operation cannot easily and rapidly add the arbitrary attribute information to the image data and cannot further display and watch a high-quality image data and attribute information simultaneously through a small number of input operations.

There is a known electronic album device which can display image data on a home TV (refer to Japanese Laid-Open Patent Publication No. 2002-66794, for example).

However, although such an electronic album device can display the image data on TV, it cannot readily display the image data without using TV in a room or office.

There is also a known electronic album device in which attribute information is inputted using a keyboard displayed on a screen (refer to Japanese Laid-Open Patent Publication No. 7-282077, for example).

However, in such an electronic album device, a user has to indicate an arbitrary key of the keyboard displayed on the screen by putting a cursor on the key to input the attribute information, so that the input operation becomes complicated. Moreover, the above electronic album devices cannot display the image data and the attribute information on separate screens. Furthermore, the above electronic album devices cannot treat folders which are recorded in physically-different memory cards as logically one folder depending on circumstances.

### DISCLOSURE OF THE INVENTION

In order to solve the problem of the conventional art described above, an object of the present invention is to provide a photo album controller which can simultaneously display a high-quality image data and attribute information on separate screens through a small number of input operations without TV by automatically converting a predetermined attribute information to regenerate a predetermined image data easily and rapidly and can further treat folders which are recorded in physically-different memory cards as logically one folder depending on circumstances.

To achieve the above object, a photo album controller according to one aspect of the present invention includes a display means by which an image data is displayed, an input means by which a user inputs a character information or an operating instruction, a controller which controls a whole apparatus, and a main memory unit which records a control program to control the whole apparatus, wherein a memory card slot into which a memory card, which records the image data, is inserted is provided, the input means can be detached from the photo album controller, has a power button to control a power supply to the photo album controller, and has a wired or wireless communication with the photo album controller, the display means has a first display screen to display the image data and a second display screen to display a folder name of a folder stored in the memory card or a shooting date and time provided to the image data as attribute information, a controller determines whether or not the folder name which is provided to the predetermined folder stored in the memory card corresponds to a format which is provided by Exif (Exchangeable image file format) function when the memory card is inserted into the memory card slot, and when determining that the format of the folder name does not correspond to the format provided by the Exif function, the controller displays the folder name on the second display screen and also displays the predetermined image data stored in the predetermined folder on the first display screen, and when determining that the format of the folder name corresponds to the format provided by the Exif function, the controller determines whether or not the shooting date and time provided to the predetermined image data which is stored in the predetermined folder corresponds to the format provided by the Exif function, and moreover, when determining that the format of the shooting date and time does not correspond to the format provided by the Exif function, the controller displays the shooting date and time on the second display screen and also displays the predetermined image data on the first display screen, and when determining that the format of the shooting date and time corresponds to the format provided by the Exif function, the controller converts the shooting date and time into a display using letters of “year”, “month”, “day”, “time”, “minute”, or “second”, provides the converted shooting date and time to the predetermined image data as a new shooting date and time, displays the new shooting date and time on the second display screen, and displays the predetermined image data on the first display screen.

According to the above configuration, the controller determines whether or not the folder name of the folder stored in the memory card is arbitrarily provided by the user in accordance with the determination whether or not the folder name corresponds to the format provided by the Exif function. In the present invention, “the format provided by the Exif function” indicates a format which enables a regeneration compatibility among various apparatuses, which treat image files taken by the digital camera. Specifically, the above format is set out in the latest standard which is standardized from 1999 prior to the application date of the present invention (JEITA, CP-3451, Exchangeable image file format standard for digital still camera Exif 2.2 established in April 2002 and JEITA CP-3461, Design rule for Camera File system DCF 2.0 established in September 2003). When the folder name is arbitrarily provided by the user, the controller displays the folder name on the second display screen. When the folder name is not arbitrarily provided by the user, the controller displays the shooting date and time of the image data stored in the folder using the letters of “year”, “month”, “day” “time”, “minute”, or “second” on the second display screen. Accordingly, the user can easily acknowledge the contents of the image data and the shooting status of the image data by visually recognizing the folder name which is arbitrarily provided and the shooting date and time designated by the letters while watching the high-quality image data displayed on the first display screen.

In another aspect of the present invention, upon a press of the power button during the display of the predetermined image data on the first display screen and the display of the attribute information on the second display screen, the controller firstly makes the main memory unit associate the image data with the attribute information and record them as a final display state, secondly stops a power supply to the photo album controller, and subsequently, when the power supply to the photo album controller starts by the press of the power button again, the controller displays the image data and the attribute information on the first display screen and the second display screen in accordance with the final display state.

According to the above configuration, the controller makes the main memory unit record the image data and the attribute information displayed on the first display screen and the second display screen just before the photo album controller is turned off. When the power supply to the photo album controller starts, the controller displays the image data and the attribute information which were displayed just before the photo album controller is turned off on the first display screen and the second display screen. Consequently, the user can visually recognize and watch the previous high-quality image data and attribute information displayed just before the photo album controller is turned off with a remarkably simple input operation of pressing the button once when starting the photo album controller to use again.

In yet another aspect of the present invention, the input means further includes an arrow key, an ANK (Alphabet Numeric Kana) key, a function key, or a numeric key to input a letter and an operating instruction to the photo album controller, the first display screen displays a folder name change screen for changing the folder name and a comment entry screen for the user inputting the arbitrary comment and for associating the comment with the image data in response to the input of the operating instruction via the input means, and when the first display screen displays the folder name change screen, the controller changes the folder name in response to the input of the letter or the operating instruction via the input means and then makes the memory card record the changed folder name as a new folder name, and when the first display screen displays the comment entry screen, the controller associates the inputted comment with the image data and makes the memory card record them as a slide show in response to the input of the letter or the operating instruction via the input means.

According to the above configuration, the user can change the folder name of the folder stored in the memory card by using the input means and can further provide the comment such as a key word and a sentence to the image data. Moreover, the user can set up a predetermined favorite folder as an image album by using the input means.

In yet another aspect of the present invention, the input means further includes an image album auto play button for regenerating the image album and a slide show auto play button for regenerating the slide show, and the controller displays all folder names stored in the memory card on the first display screen in response to the press of the image album auto play button and further selects the folder name according to how many times the image album auto play button is pressed and subsequently, the controller displays the image data stored in the folder to which the selected folder name is provided sequentially in a regular interval in accordance with a condition that the image album auto play button is not pressed in a predetermined period of time and also displays the comment and the image data associated and recorded in the memory card simultaneously on the first display screen in response to the press of the slide show auto play button.

In accordance with the configuration, the user can display the image data stored in the predetermined folder which is set up as the image album sequentially in the regular interval on the first display screen by pressing the image album auto play button. Moreover, the user can display the image data and the comment provided to the image data simultaneously on the first display screen by pressing the slide show auto play button.

In yet another aspect of the invention, the photo album controller further includes a first memory card slot and a second memory card slot, and in case that a folder name of a first folder stored in a first memory card is identical with a folder name of a second folder stored in a second memory card when the first and second memory cards are inserted into the first and second memory card slot, respectively, the controller determines the first folder and the second folder to be logically one folder and controls the first folder, the second folder, the image data stored in the first folder, and the image data stored in the second folder.

In accordance with the configuration, when the folder names of the folders stored in the first and second memory cards, respectively, are identical with each other, the controller treats these folders as logically one folder. Consequently, the user can collect and set up the plural folders stored in the physically-different memory cards as an image album.

### BRIEF DESCRIPTION OF THE DRAWINGS

FIG. 1 is an outline view of a photo album controller according to the present preferred embodiment.

FIG. 2 is a configuration diagram of the photo album controller according to the present preferred embodiment.

FIG. 3 is an outline view of a remote controller according to the present preferred embodiment.

FIG. 4 is an outline view of a first operation key group according to the present preferred embodiment.

FIG. 5 is an outline view of a second operation key group according to the present preferred embodiment.

FIG. 6 is an outline view of a third operation key group according to the present preferred embodiment.

FIGS. 7A and 7B are diagrams showing a state when an image data and attribute information are displayed.

FIG. 8 is a flow chart of a display processing for displaying the image data performed by an image display screen according to the present preferred embodiment.

FIG. 9 is a diagram showing a folder configuration in a memory card according to the present preferred embodiment.

FIG. 10 is a diagram showing the image display screen when an image album auto play button according to the present preferred embodiment is pressed.

FIG. 11 is a flow chart of an image album regeneration processing for regenerating the image album performed by the image display screen according to the present preferred embodiment.

FIG. 12 is a diagram showing the image display screen when a slide show auto play button according to the present preferred embodiment is pressed.

FIG. 13 is a flow chart of the slide show regeneration processing for regenerating the slide show performed by the image display screen according to the present preferred embodiment.

FIG. 14 is a diagram showing the image display screen when a MENU button according to the present preferred embodiment is pressed.

FIG. 15 is a diagram of a folder name change screen according to the present preferred embodiment.

FIG. 16 is a diagram of a slide show title setting screen according to the present preferred embodiment.

FIG. 17 is a diagram of a sentence entry screen according to the present preferred embodiment.

### DESCRIPTION OF THE PREFERRED EMBODIMENTS

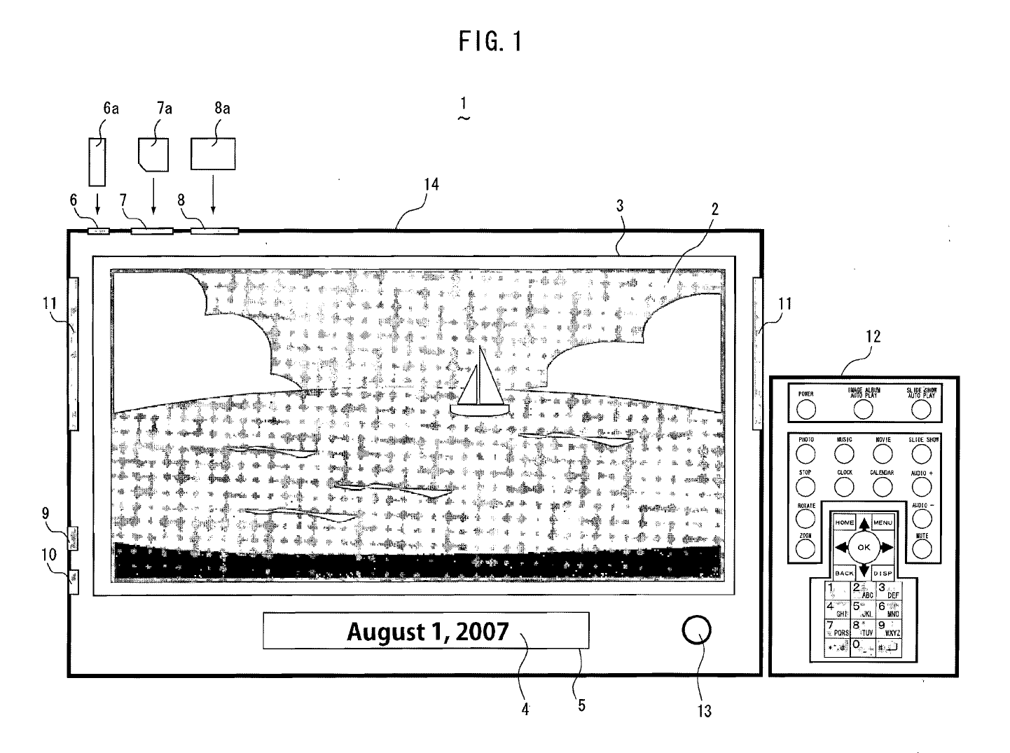

A photo album controller according to the preferred embodiment of the present invention is described with reference to FIGS. 1 to 17. FIG. 1 shows an outline of the photo album controller according to the preferred embodiment of the present invention. The photo album controller 1 includes a main body 14 and a remote controller 12. The main body 14 is made up of a liquid crystal screen displaying an image data 2 on one surface of a housing having substantially rectangular parallelepiped shape and has an image display screen 3 (first display screen), an attribute information display screen 5 to display an attribute information 4 of the image data 2 (second display screen), a memory card slots 6 to 8, a USB terminal 9, a communication line terminal 10, a speaker 11, and a remote controller signal receiver 13 to receive remote control signals from the remote controller 12 (input means) which is used for operating the photo album controller 1. The remote controller 12 can be detached from the main body 14.

The attribute information display screen 5 is located below the image display screen 3 and displays a shooting date on which the image data 2 is taken or a folder name which holds the image data 2 as the attribute information 4 of the image data 2, for example. Memory cards 6a to 8a are inserted into the memory card slots 6 to 8, respectively. In the present preferred embodiment, the memory card 7a is a memory stick, the memory card 8a is a SD card, and the memory card 8a is a compact flash memory card. The USB terminal 9 exchanges data with an external device such as a digital camera and a personal computer when a USB cable is inserted, and the communication line terminal 10 communicates with the personal computer, a mobile phone, and so on over a LAN cable and a phone line. The speaker 11 is located on left and right sides of the main body 14 and outputs an audio stored in the memory cards 6a to 8a. The image display screen 3 is as large as a postal card or a B-5 size notebook, for example, so that the photo album controller 1 is small enough to be carried by a user. Moreover, the photo album controller 1 can be put on a table, a desk, a bay window, or a shelf in a room or an office, for example, to be used similarly to a photo frame in which an analog photograph is put.

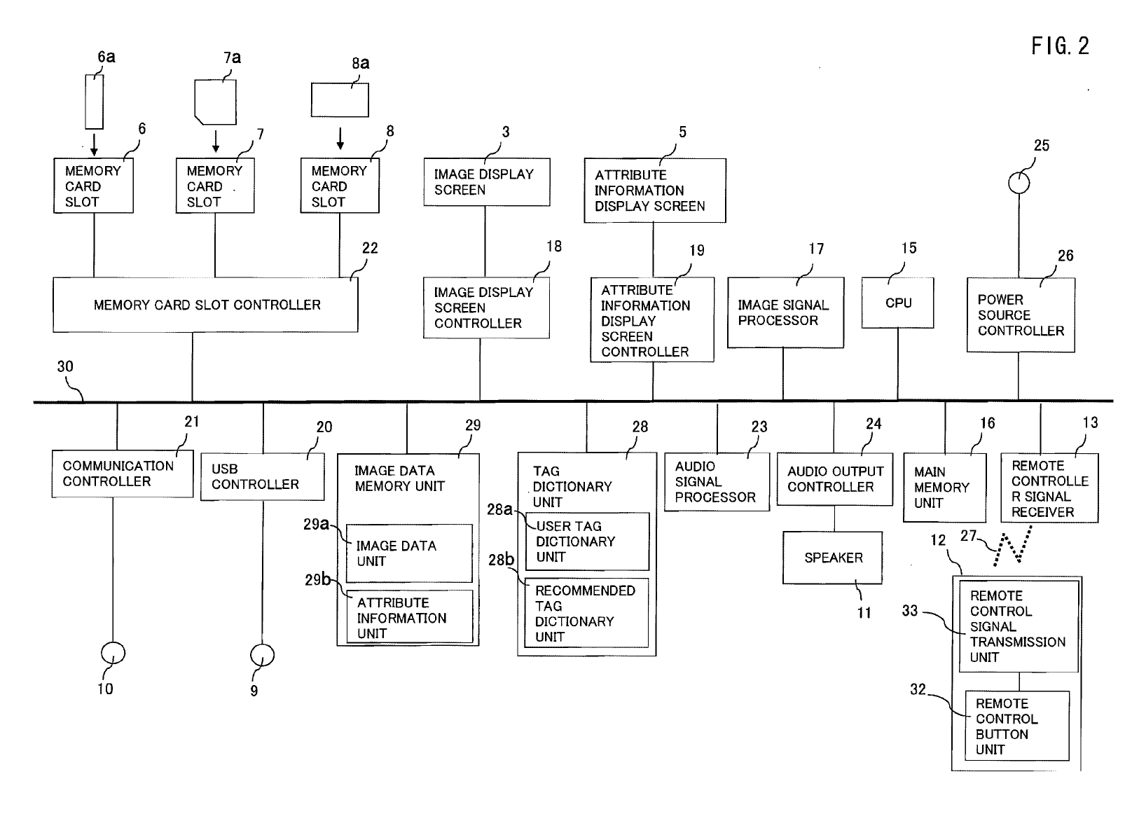

FIG. 2 shows a configuration of the photo album controller 1 according to the present preferred embodiment. The photo album controller 1 includes a CPU 15 (controller) which controls a whole apparatus, a main memory unit 16 which records a control program to control the whole apparatus, an image signal processor 17 which processes signals for the image data 2 stored in the memory cards 6a to 8a, an image display screen controller 18 which controls the image display screen 3, an attribute information display screen controller 19 which controls the attribute information display screen 5, a USB controller 20 which controls the USB terminal 9, a communication controller 21 which controls the communication terminal 10, a memory card slot controller 22 which controls the memory card slots 6 to 8, an audio signal processor 23 which processes signals for an audio stored in the memory cards 6a to 8a, an audio output controller 24 which controls the speaker 11, a power source controller 26 which controls a power source 25 of the photo album controller 1, a remote control signal receiver 13 which receives a remote control signal 27 from the remote controller 12, a tag dictionary unit 28 which records plural words as a tag, and an image data memory unit 29 which records the image data 2, and they are connected to a bus 30. The tag dictionary unit 28 has a user tag dictionary unit 28a which records words inputted by the user as a user tag and a recommended tag dictionary unit 28b which records pre-set plural words as a recommended tag. The image data memory unit 29 has an image data unit 29a which records the image data 2 and an attribute information unit 29b which records the attribute information 4 of the image data 2. The remote controller 12 has a remote control signal transmission unit 33 which transmits the remote control signal 27 to the remote control signal receiver 13 in response to a press of a remote control button unit 32.

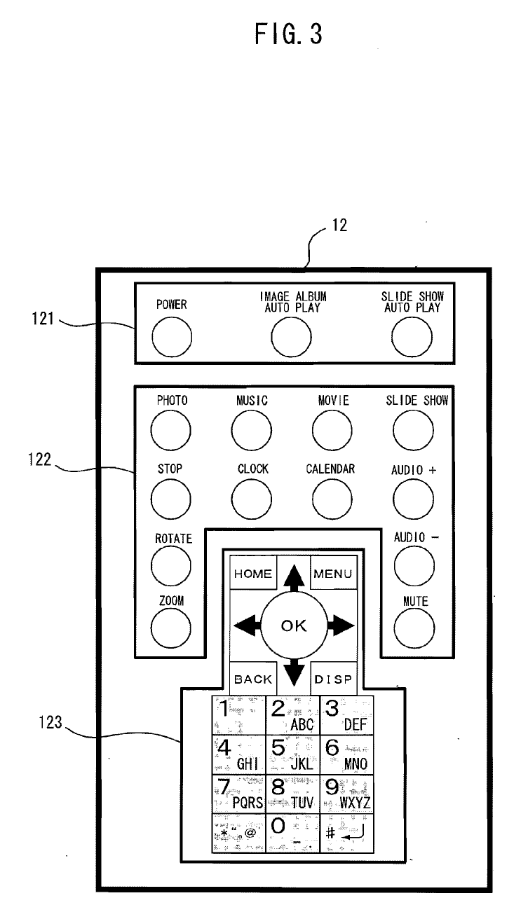

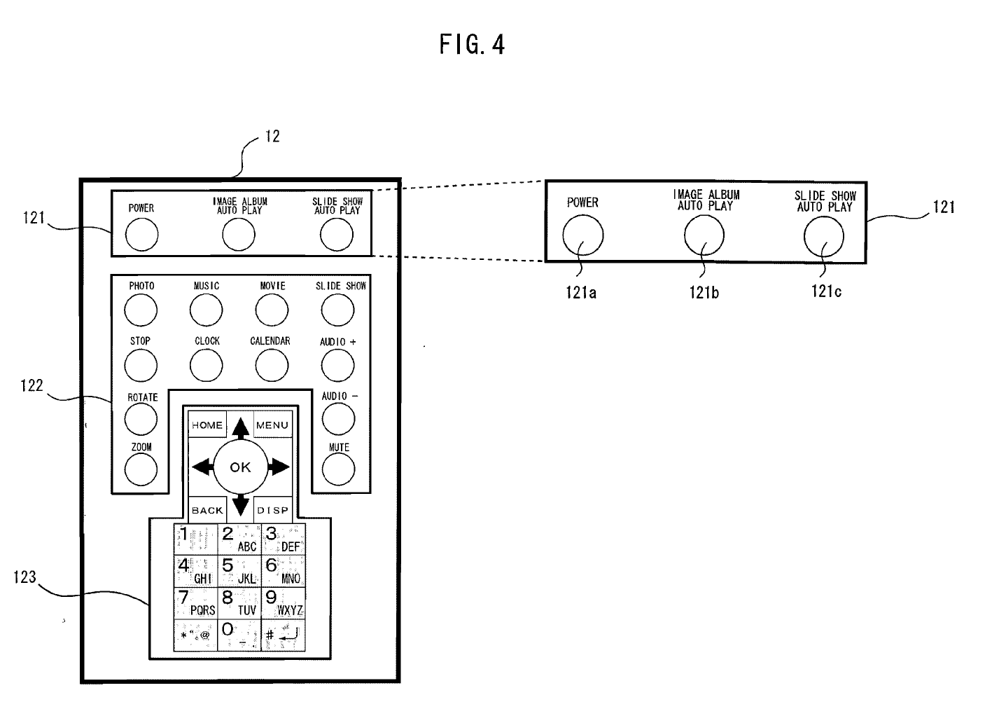

FIG. 3 shows an outline of the remote controller 12. The remote controller 12 is made up of a first operation key group 121 having three types of operation buttons, a second operation key group 122 having twelve operation buttons, and a third operation key group 123 having an arrow key and numeric key. FIG. 4 shows a configuration of the first operation key group 121. The first operation key group 121 has a power button 121a which controls the power source 25, an image album auto play button 121b which regenerates the image data 2 stored in a folder which is pre-set as an image album by the user, and a slide show auto play button 121c which regenerates the image data 2 and letters which are pre-set as a slide show by the user. The user can regenerate the image data 2 quite easily through a small number of input operations by operating the first operation key group 121.

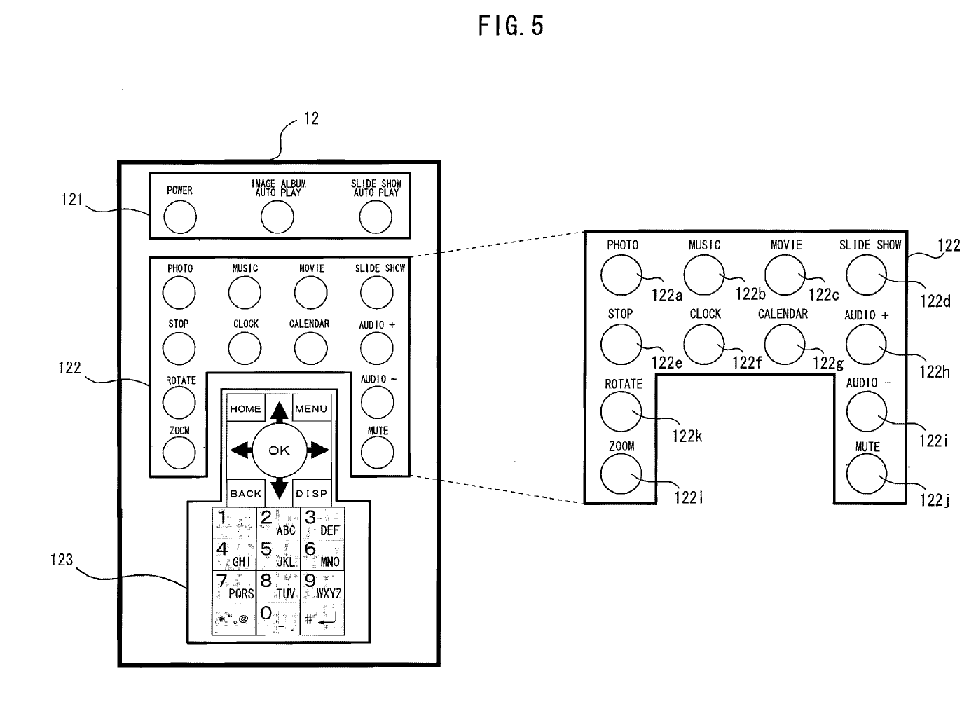

FIG. 5 shows a configuration of the second operation key group 122. The second operation key group 122 includes a photo button 122a to display the image data 2 on the image display screen 3, a music button 122b to output the audio from the speaker 11, a movie button 122c to make the image display screen 3 and the speaker 11 regenerate a movie stored in the memory cards 6a to 8a, a slide show button 122d to regenerate the slide show which is pre-set by the user, a stop button 122e to stop each operation, a time button 122f to display a time on the image display screen 3, a calendar button 122g to display a calendar on the image display screen 3, an audio + button 122h to increase the audio volume outputted from the speaker 11, an audio − button 122i to decrease the audio volume outputted from the speaker 11, a mute button 122j not to output the audio from the speaker 11, a rotation button 122k to rotate the image data 2 displayed on the image display screen 3 90 degrees rightward with each press of the rotation button 122k, and a zoom button 122l to enlarge a center of the image data 2 displayed on the image display screen 3. The user can make the photo album controller 1 perform the various operations with the simple operation of the second operation key group 122.

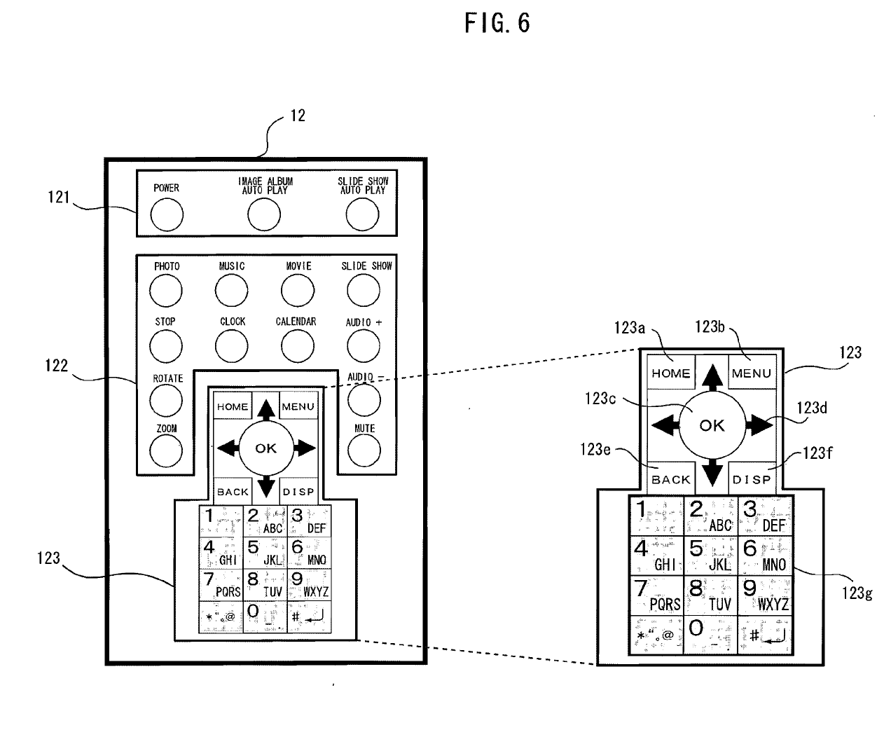

FIG. 6 shows a configuration of the third operation key group 123. The third operation key group 123 includes a HOME button 123a (function key) to return the photo album controller 1 to its original state, a MENU button 123b (function key) to display an operation menu on the image display screen 3, an OK button 123c to determine an instruction selected by the user, an arrow key 123d to determine a direction, that is, up, down, right, and left, a BACK button 123e (function key) to return the operation performed on the photo album controller 1 to the last operation state, a DISP button 123f (function key) to display an explanation and clue for the operation on the image display screen 3, and an ANK key 123g used for inputting a number, a code, and a letter. The user can select a desired folder and image data 2 by operating the third operation key group 123. The user can also change the folder name stored in the memory cards 6a to 8a by operating the ANK key 123g. The user can further set up the predetermined folder as the image album by operating the third operation key group 123. When the image album auto play button 121b is pressed after the image album is set up, the image display screen 3 displays the image data 2 stored in the predetermined folder which is set up as the image album.

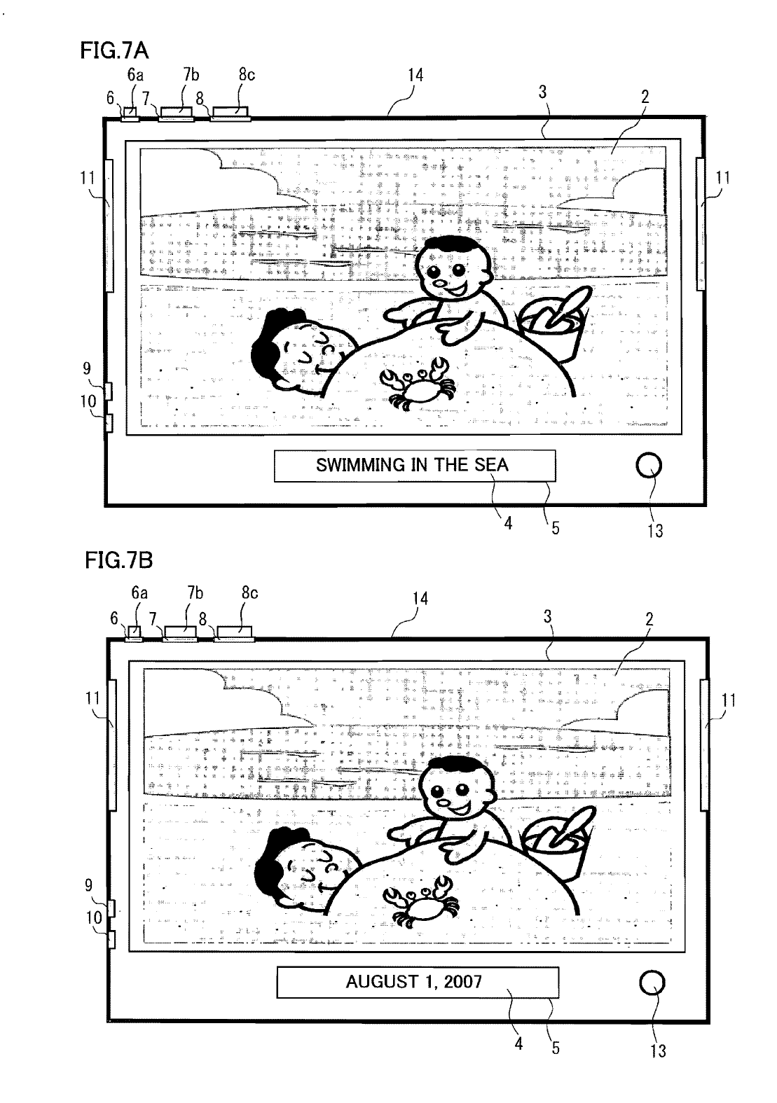

FIGS. 7A and 7B show a state when the photo album controller 1 displays the image data 2 and the attribute information 4. FIG. 7A shows a state when the folder name is displayed as the attribute information 4 displayed on the attribute information display screen 5, and FIG. 7B shows a state when the shooting date of the image data 2 is displayed as the attribute information 4 displayed on the attribute information display screen 5. In FIG. 7A, the image display screen 3 displays the image data 2, and the attribute information display screen 5 displays the folder name “swimming in the sea” of the folder which stores the image data 2 as the attribute information 4. When the folder name of the folder which stores the image data 2 is changed by the user, the photo album controller 1 displays the folder name on the attribute information display screen 5. At this time, the photo album controller 1 determines that the folder name is changed by the user when the folder name does not correspond to a format provided by the Exif function.

In FIG. 7B, the image display screen 3 displays the image data 2, and the attribute information display screen 5 displays the shooting date “Aug. 1, 2007” on which the image data 2 is taken as the attribute information 4. When the folder name of the folder which stores the image data 2 is not changed by the user, the photo album controller 1 displays the shooting date on the attribute information display screen 5. In this manner, the photo album controller 1 displays the attribute information 4 on the attribute information display screen 5 which is provided separately from the image display screen 3 on which the image data 2 is displayed, so that a partial defect of the image data 2 caused by displaying and superimposing the attribute information 4 on the image data 2 can be avoided. The user can acknowledge the shooting status and time of the image data 2 by visually recognizing the high-quality image data 2 and the attribute information 4 simultaneously, so that the user can enjoy watching the image data.

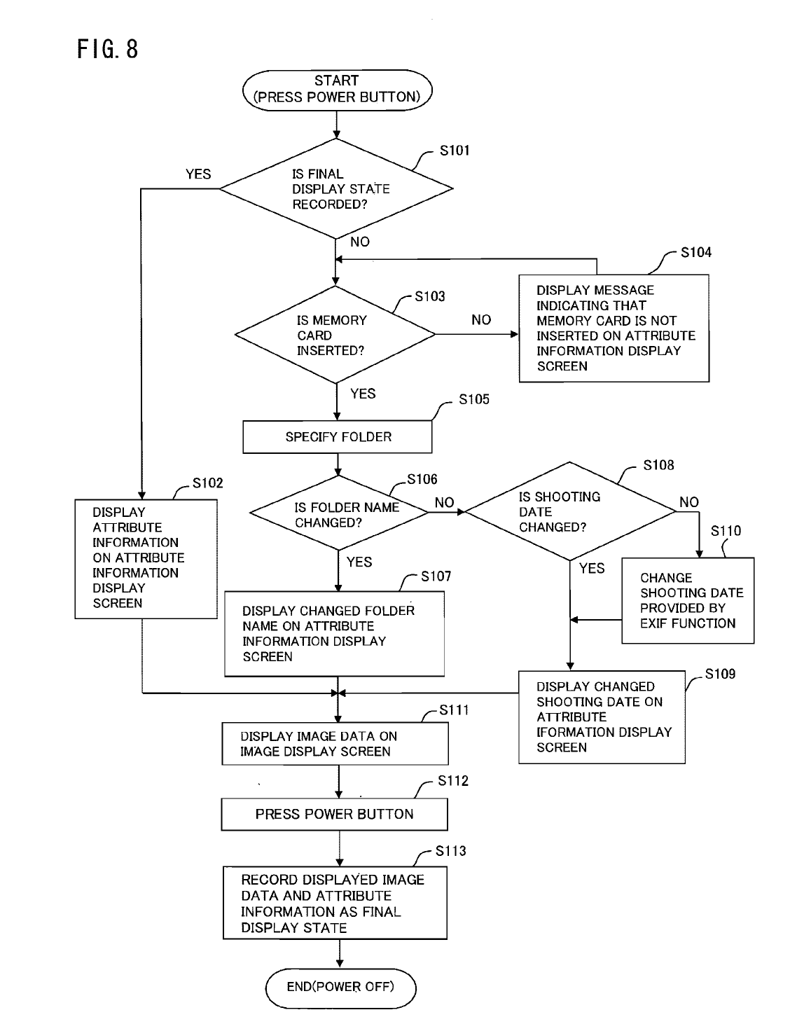

FIG. 8 shows a flow chart of a display processing for displaying the image data 2 performed by the image display screen 3. When the user presses the power button 121a, the CPU 15 determines whether or not the main memory unit 16 records the image data 2 and the attribute information 4 as a final display state (S101). At this time, the final display state indicates the image data 2 and the attribute information 4 displayed on the image display screen 3 and the attribute information display screen 5 when the power supply to the photo album controller 1 is stopped. When the main memory unit 16 records the final display state in the step S101 (Yes in S101), the attribute information display screen 5 displays the attribute information 4 recorded as the final display state (S102), and the image display screen 3 displays the image data 2 recorded as the final display state (S111). Accordingly, the user can watch the previous high-quality image data 2 and attribute information 4 displayed just before the photo album controller 1 is turned off with a remarkably simple input operation of pressing the power button 121a once.

When the main memory unit 16 does not record the final display state in the step S101 (No in S101), the CPU 15 determines whether or not the memory card 6a, 7a, or 8a is inserted into the memory card slot 6, 7, or 8 (S103). When none of the memory cards 6a to 8a is inserted into the memory card slots 6 to 8 in the step S103 (No in S103), the CPU 15 displays a message to prompt the insertion of the memory cards 6a to 8a on the attribute information display screen 5 and waits for the memory cards 6a to 8a to be inserted (S104). On the contrary, when the memory card 6a, 7a, or 8a is inserted into the memory card slot 6, 7, or 8 in the step S103 (Yes in S103), the CPU 15 specifies one folder in the folders stored in the memory cards 6a to 8a (S105). In the present preferred embodiment, the specified folder is a folder whose creation date is oldest, for example.

Subsequently, the CPU 15 determines whether or not the folder name of the specified folder is changed by the user (S106). When the format of the folder name does not correspond to the format provided by the Exif function, the CPU 15 determines that the folder name is changed by the user. When the CPU 15 determines that the folder name is changed by the user in the step S106 (Yes in S106), the CPU 15 displays the folder name changed by the user as the attribute information 4 on the attribute information display screen 5 (S107). Then, the CPU 15 specifies one image data 2 in the plural image data 2 stored in the specified folder and displays it on the image display screen 3 (S111). In the present preferred embodiment, the CPU 15 specifies the image data 2 whose shooting date is oldest as the image data 2 displayed on the image display screen 3, for example. When the power button 121a is pressed, the image display screen 3 and the attribute information display screen 5 display the image data 2 and the folder name changed by the user depending on circumstances. According to the above configuration, the user can visually recognize the folder name changed by the user in addition to the image data 2, so that the user can easily acknowledge the shooting status of the image data 2.

When the CPU 15 determines that the folder name is not changed by the user in the step S106 (No in S106), the CPU 15 specifies one image data 2 in the plural image data 2 stored in the specified folder. In the present preferred embodiment, the CPU 15 specifies the image data 2 whose shooting date is oldest as the image data 2 displayed on the image display screen 3, for example. The CPU 15 determines whether or not the shooting date of the specified image data 2 is changed (S108). In the present preferred embodiment, the CPU 15 determines that the shooting date is changed when the shooting date of the image data 2 is expressed by “year”, “month”, or “day” instead of the format provided by the Exif function. When the CPU 15 determines that shooting date is changed in the step S108 (Yes in S108), the CPU 15 displays the changed shooting date as the attribute information 4 on the attribute information display screen 5 (S109). Then the CPU 15 displays the specified image data 2 on the image data screen 3 (S111).

When the CPU 15 determines that shooting date of the specified image data 2 is not changed in the step S108 (No in S108), the CPU 15 changes the shooting date provided by the Exif function to the shooting date expressed by “year”, “month”, or “day” (S110). At this time, the CPU 15 associates the changed shooting date with the image data 2 by overwriting the shooting date provided by the Exif function with the changed shooting date. Then the CPU 15 displays the changed shooting date as the attribute information 4 on the attribute information display screen 5 (S109) and displays the specified image data 2 on the image display screen 3 (S111). When the power button 121a is pressed, the image display screen 3 and the attribute information display screen 5 display the image data 2 and the changed shooting date depending on circumstances. Accordingly, the attribute information display screen 5 can display the shooting date using the letters of “year”, “month”, or “day” even when the user does not emit the shooting date. Moreover, the user can visually recognize the shooting date displayed as “year”, “month”, or “day” in addition to the image data 2, so that the user can easily acknowledge the time when the image data 2 is taken.

Upon the press of the power button 121a during the display of the image data 2 on the image display screen 3 and the display of the folder name or shooting date as the attribute information 4 on the attribute information display screen 5, the CPU 15 makes the main memory unit 16 record the displayed image data 2 and attribute information 4 as the final display state (S113). Accordingly, the user can watch the image data 2 and the attribute information 4 recorded by the main memory unit 16 when pressing the power button 121a next time to turn on the power. After making the main memory unit 16 record the final display state, the CPU 15 makes the power source controller 26 stop the power supply and finishes the display processing.

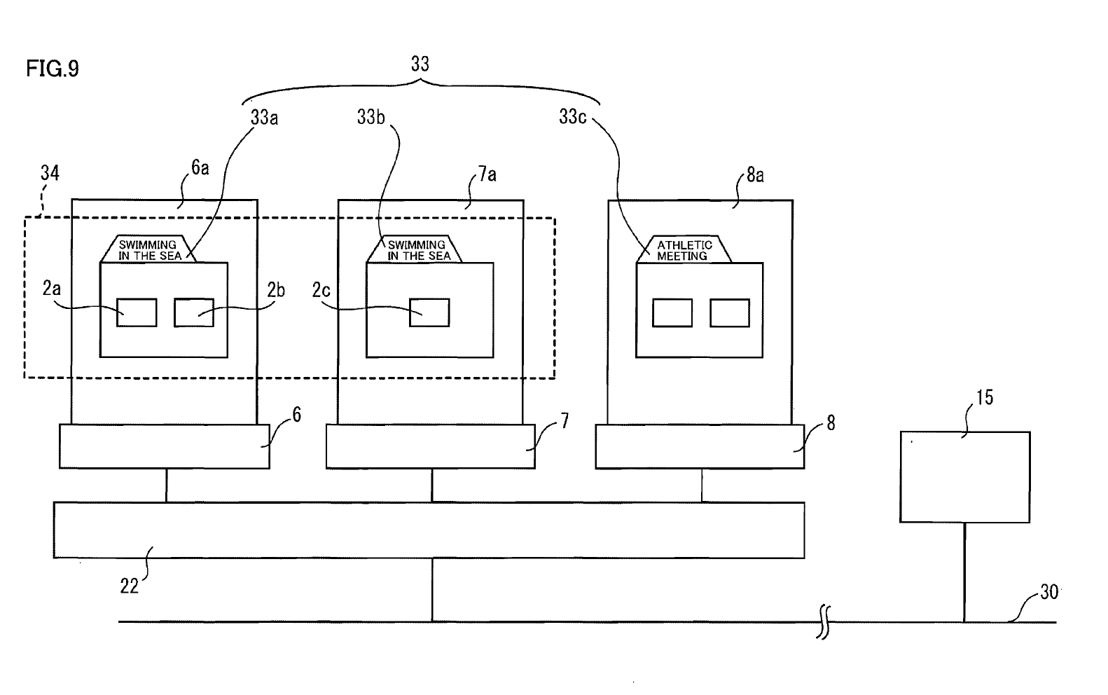

Subsequently, a handling of the folder in the photo album controller 1 is described hereinafter. FIG. 9 shows a folder configuration in the memory cards 6a to 8a. The memory card 6a stores a folder 33a whose folder name is “swimming in the sea”, the memory card 7a stores a folder 33b whose folder name is “swimming in the sea”, and the memory card 8a stores a folder 33c whose folder name is “athletic meeting”. In the present preferred embodiment, the folder 33a stored in the memory card 6a has image data 2a and 2b, and the folder 33b stored in the memory card 7a has an image data 2c. When the memory cards 6a to 8a are inserted into the memory card slots 6 to 8, the CPU 15 checks whether or not the folder names of a folder 33 stored in the memory cards 6a to 8a are identical with each other.

At this time, both of the folders 33a and 33b have the common folder name, “swimming in the sea”. When the folder names are identical with each other, the CPU 15 treats the folders 33a and 33b stored in the physically-different memory cards 6a and 7a as logically one folder 34. For example, when the folder 33a is set up as the image album and the image album auto play button 121b is pressed, the CPU 15 displays the image data 2a, 2b, and 2c stored in the logical folder 34 on the image display screen 3. Moreover, for example, when the folder name of the folder 33a is changed to “swimming in the sea in August” by the user, the CPU 15 determines that the folder name of the logical folder 34 is changed and then changes the folder name of the folder 33b to “swimming in the sea in August”.

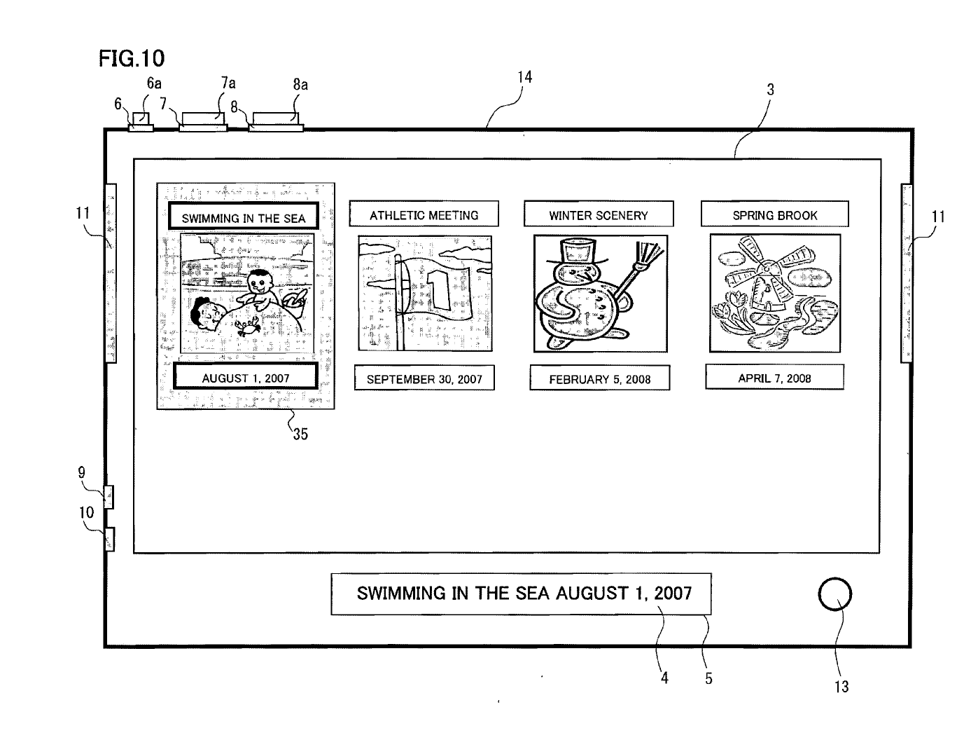

FIG. 10 shows the image display screen 3 when the image album auto play button 121b is pressed. When the image album auto play button 121b is pressed, the image display screen 3 displays folder information of all the folders 33 stored in the memory cards 6a to 8a in order of creation date of the folders 33. In the present preferred embodiment, the folder information indicates the folder name, the image data 2 whose shooting date is oldest in the plural image data 2 stored in the folder 33, and the creation date of the folder 33. Moreover, the image display screen 3 displays and superimposes a cursor 35 on the folder information displayed on a left edge of the image display screen 3. The user can acknowledge that the folder 33 whose folder name is “swimming in the sea” is selected by visually recognizing the cursor 35. At this time, the attribute information display screen 5 displays the folder name and creation date of the folder 33 on which the cursor 35 is superimposed as the attribute information 4. The user can move the cursor 35 to the next folder information by pressing the image album auto play button 121b repeatedly. Accordingly, the user can select the desired folder 33 by pressing the album image auto play button 121b repeatedly to move the cursor 35.

When the cursor 35 is superimposed on one folder information and the album image auto play button 121b is not pressed for a certain period of time, the CPU 15 determines that the user selects the folder 33 which falls under the folder information on which the cursor 35 is superimposed. At this time, the certain period of time is 10 seconds, for example. When the CPU 15 determines that the folder 33 is selected, the image display screen 3 displays the image data 2 stored in the selected folder 33 sequentially in a regular interval. At this time, the regular interval is 3 seconds, for example. The attribute information display screen 5 displays the folder name and creation date as the attribute information 4 while the image data 2 is displayed. Accordingly, the user can display the image data 2 stored in the desired folder 33 and the attribute information 4 as the image album on the image display screen 3 and the attribute information display screen 5 by operating only the image album auto play button 121b.

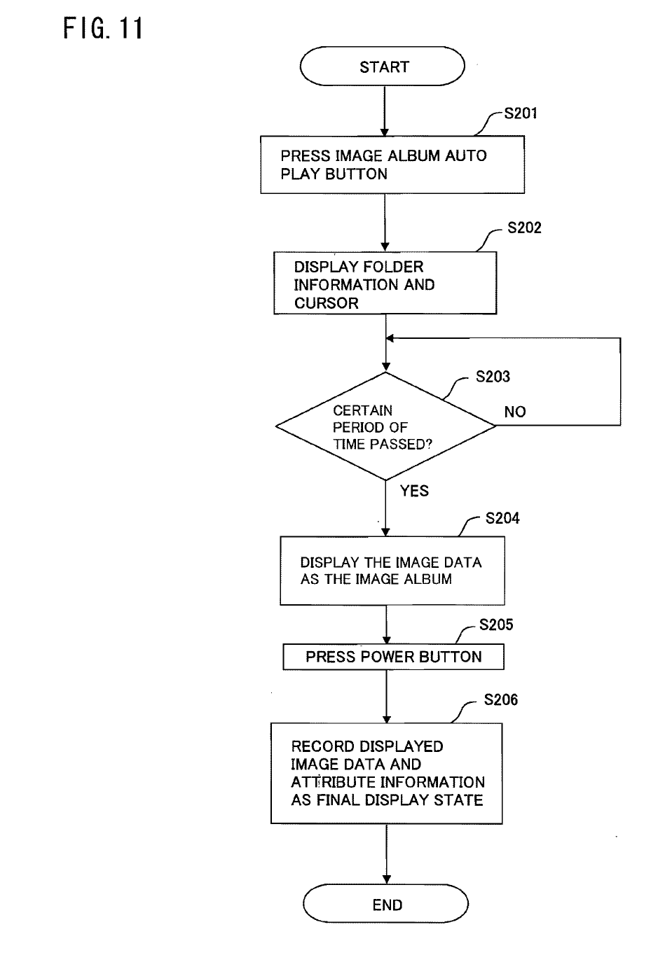

FIG. 11 is a flow chart of an image album regeneration processing for regenerating the image album performed by the image display screen 3. When the user presses the image album auto play button 121b (S201), the CPU 15 displays the folder information of all the folders 33 stored in the memory cards 6a to 8a and the cursor 35 on the image display screen 3 (S202). When the cursor 35 is superimposed on one folder information, the CPU 15 waits for the album image auto play button 121b not to be pressed for the certain period of time (No in S203). When the certain period of time passes in the step S203 (Yes in S203), the image display screen 3 displays the image data 2 stored in the selected folder 33 as the image album sequentially in the regular interval (S204). The attribute information display screen 5 displays the folder name and creation date as the attribute information 4. Subsequently, when the power button 121a is pressed (S205), the CPU 15 makes the main memory unit 16 record the displayed image data 2 and attribute information 4 as the final display state (S206) and finishes the image album regeneration processing.

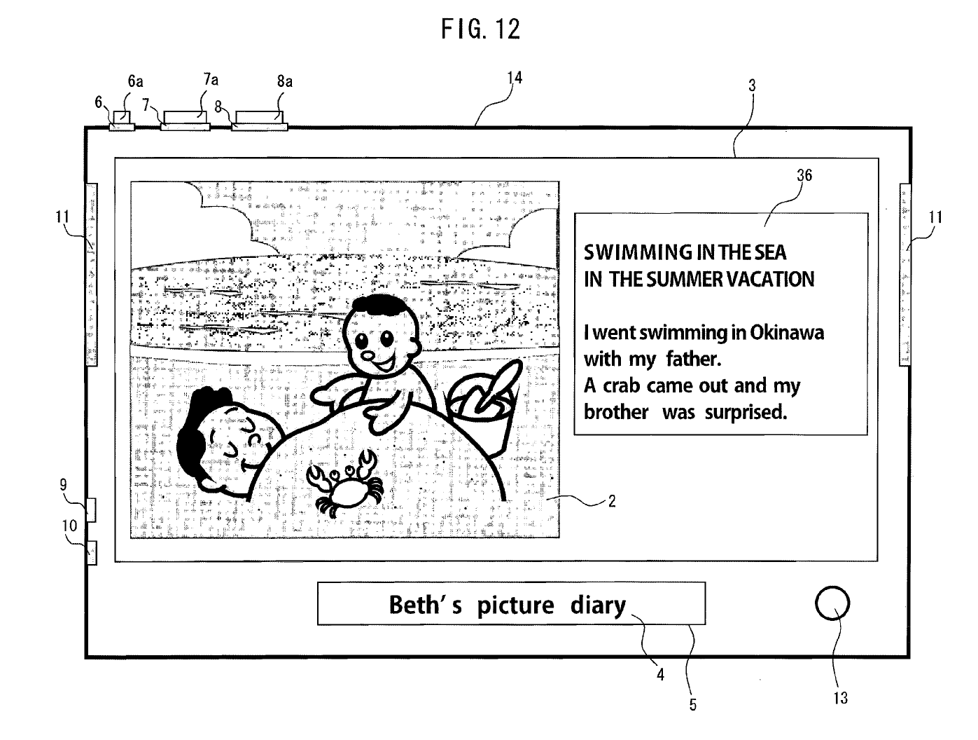

FIG. 12 shows the image display screen 3 when the slide show auto play button 121c is pressed. In the present preferred embodiment, the slide show indicates a function to display the image data 2 and a comment provided to the image data 2 by the user simultaneously on the image display screen 3 in advance. When the plural image data 2 are set up as the slide show, the photo album controller 1 displays the image data 2 and the comment sequentially in the regular interval. When the slide show auto play button 121c is pressed, the image display screen 3 displays the image data 2 and a sentence 36 provided as the comment of the image data 2 side by side. At this time, the attribute information display screen 5 displays a slide show title provided to the image data 2 and sentence 36 as the attribute information 4. In the present preferred embodiment, the slide show title is “Beth's picture diary”. When the image data 2 and the sentence 36 are set up as the slide show in advance, the user can enjoy watching the image data 2 like a picture diary by pressing only the slide show auto play button 121c. Moreover, the user can easily acknowledge a category of the slide show by checking the slide show title displayed on the attribute information display screen 4 while enjoying watching the image data 2 and the sentence 36.

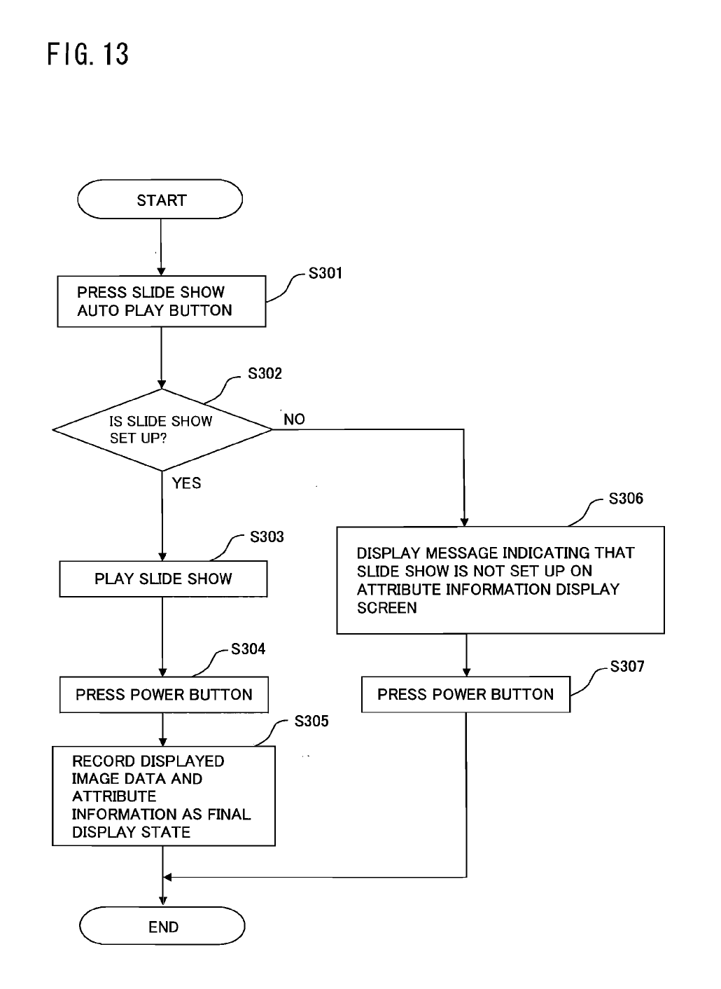

FIG. 13 is a flow chart of the slide show regeneration processing for regenerating the slide show performed by the image display screen 3. When the user presses the slide show auto play button 121c (S301), the CPU 15 determines whether or not the slide show is set up (S302). In the present preferred embodiment, the setup information of the slide show is recorded in the main memory unit 16. When the slide show is set up (Yes in S302), the CPU 15 makes the image display screen 3 and the attribute information display screen 5 regenerate the slide show (S303). At this time, when an audio stored in the memory cards 6a to 8a is associated as the slide show in addition to the image data 2 and the sentence 36, the speaker 11 outputs the associated audio. Accordingly, the user can watch the slide show while enjoying a mood of the audio. Subsequently, when the power button 121a is pressed (S304), the CPU 15 makes the main memory unit 16 record the displayed image data 2 and attribute information 4 as the final display state (S305) and finishes the slide show regeneration processing. When the slide show is not set up in the step S302 (No in S302), the CPU 15 displays a message indicating that the slide show is not set up on the attribute information display screen 5 (S306). Then, when the power button 121a is pressed (S307), the CPU 15 finishes the slide show regeneration processing without making the main memory unit 16 record the final display state.

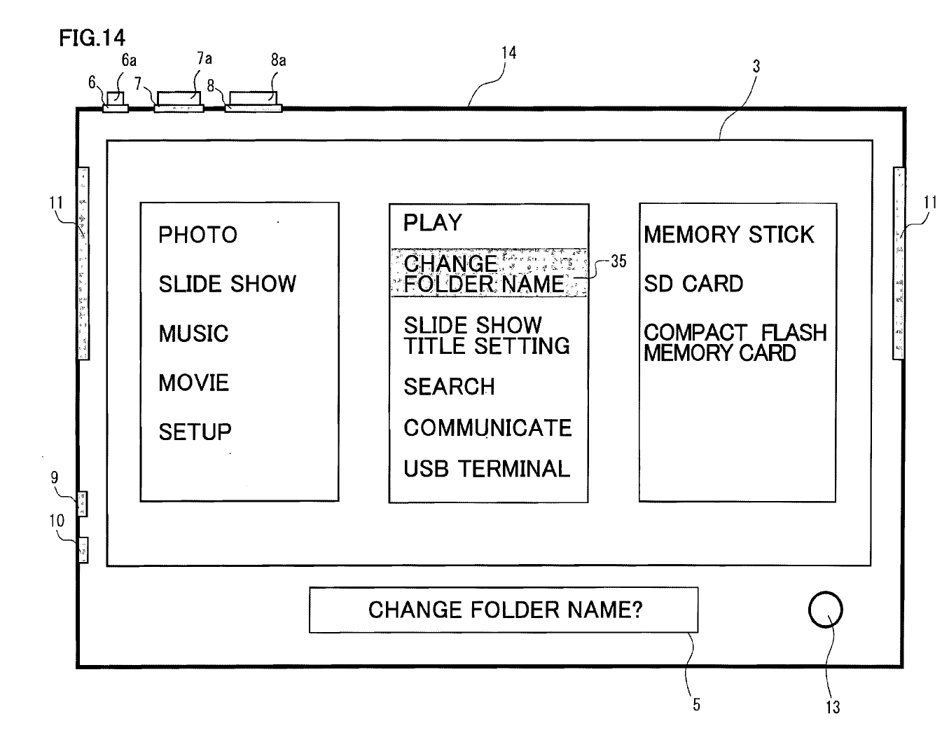

FIG. 14 shows the image display screen 3 when the MENU button 123b is pressed. When the user presses the MENU button 123b, the image display screen 3 displays a menu for performing various operations or setup. The user can perform the desired operation or setup by moving the cursor 35 using the arrow key 123d and pressing the OK button 123c to select the menu. At this time, the attribute information display screen 5 displays a description message, a confirmation message, and so on corresponding to the menu selected by the user. The user can avoid an erroneous operation by checking the message displayed on the attribute information display screen 5.

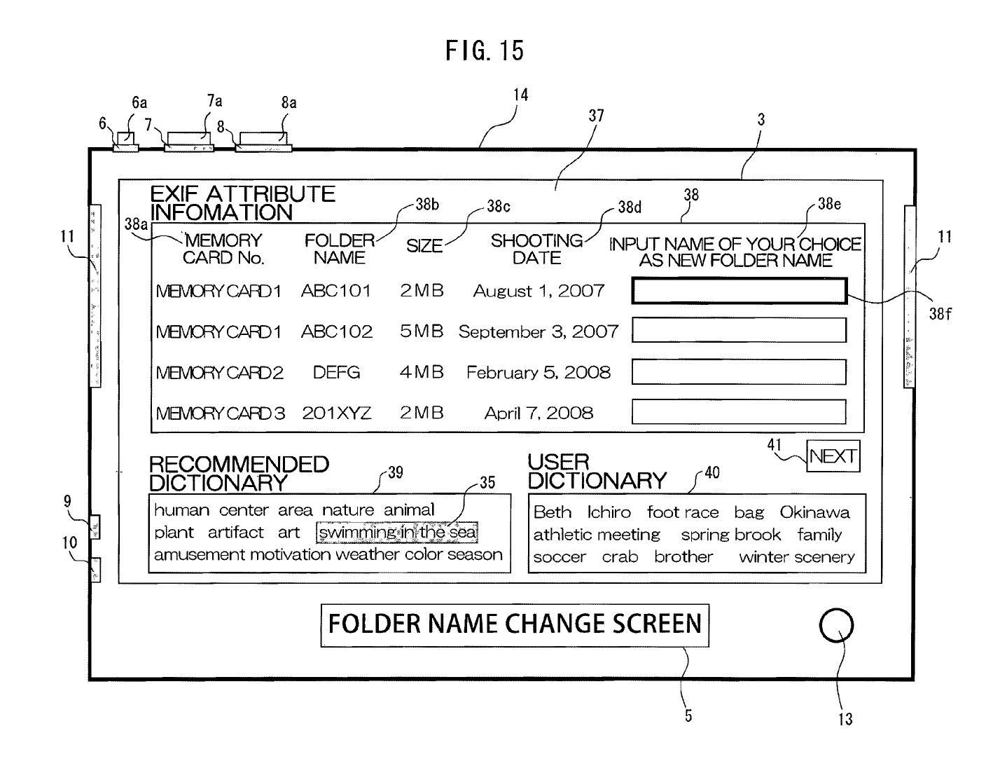

FIG. 15 shows a folder name change screen to change the folder name. When the user selects the operation to change the folder name of the folder 33 after pressing the MENU button 123b, the image display screen 3 displays a folder name change screen 37. The attribute information display screen 5 displays a message indicating that the folder name change screen 37 is displayed. The folder name change screen 37 includes an EXIF attribute information window 38 to display the attribute information 5 of the folder 33 provided by the Exif function, a recommended dictionary window 39 to display the words stored in the recommended tag dictionary unit 28b, a user dictionary window 40 to display the plural words stored in the user tag dictionary unit 28a, and a NEXT button 41 to switch the folder name change screen 37. The EXIF attribute information window 38 includes a card No. item 38a to display which of the memory card 6a, 7a, or 8a stores the folder 33, a folder name item 38b to display the folder name provided by the Exif function, a size item 38c to display a size of the folder 33, a shooting date item 38d to display a shooting date of the image data 2, and a folder name input item 38e to which the changed folder name is inputted. The folder name input item 38e displays a cell 38f to which the letters are inputted by the user in a thick-frame pattern. Accordingly, the user can acknowledge which folder name of the folder 33 is to be changed.

The recommended dictionary window 39 displays the plural words which are pre-set and stored in the recommended tag dictionary unit 28b. The user dictionary window 40 displays the plural words inputted by the user using the ANK key 123g. In FIG. 15, the cursor 35 is superimposed on the term “swimming in the sea” displayed on the recommended dictionary window 39. Under this condition, the user can input the term “swimming in the sea” to the cell 38f by pressing the OK button 123c. Accordingly, the user can easily and rapidly input the letters to the cell 38f by selecting the term displayed on the recommended dictionary window 39 or the user dictionary window 40. Moreover, the user can simply change the folder name of the folder 33 provided by the Exif function to a favorite folder name by using the folder name change screen 37.

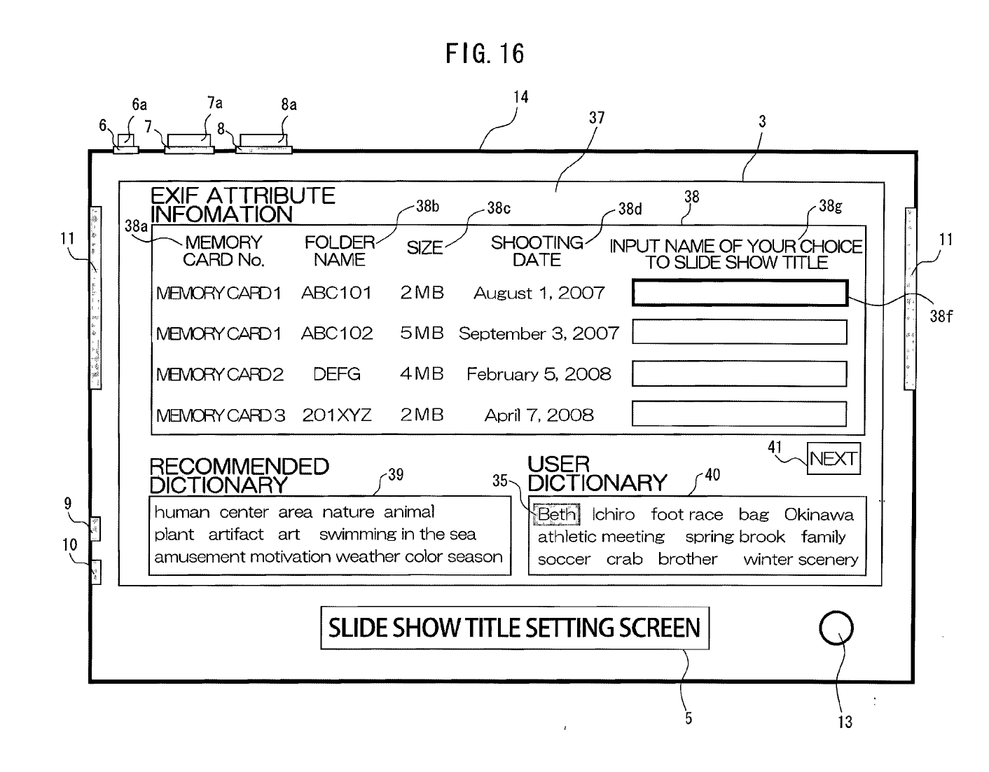

FIG. 16 is a slide show title setting screen to set up the slide show title. When the user selects the operation to set up the slide show title for the folder 33 after pressing the MENU button 123b, the image display screen 3 displays a slide show title setting screen 42. The attribute information display screen 5 displays a message indicating that the slide show title setting screen 42 is displayed. The slide show title setting screen 42 has a configuration identical with the folder name change screen 37, however, it has a title input item 38a to which the slide show title is input instead of the folder name input item 38e. In FIG. 16, the cursor 35 is superimposed on the word “Beth” displayed on the user dictionary window 40. Under this condition, the user can input the word “Beth” to the cell 38f by pressing the OK button 123c. Accordingly, the user can set up the favorite slide show title to the desired folder 33 by using the slide show title setting screen 42.

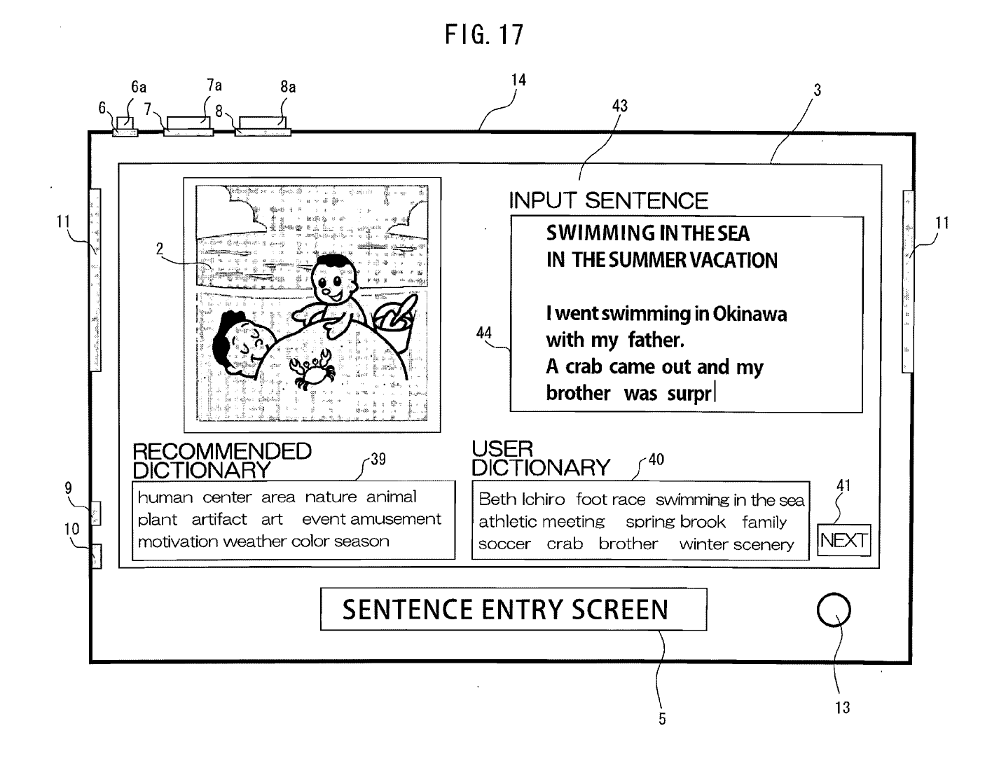

FIG. 17 shows a sentence entry screen to which the sentence is inputted by the user. When the user selects the operation to input the sentence associated with the image data 2 after pressing the MENU button 123b, the image display screen 3 displays a sentence entry screen 43. The attribute information display screen 5 displays a message indicating that the sentence entry screen 43 is displayed. The sentence entry screen 43 includes the image data 2 with which the sentence 36 is associated, a sentence entry item 44 to which the sentence is inputted by the user, the recommended dictionary window 39, the user dictionary window 40, and the NEXT button 41. The image display screen 3 displays the image data 2 and the sentence entry item 42 next to each other and also displays the recommended dictionary window 39, the user dictionary window 40, and the NEXT button 41 in a row sideways below the image data 2 and the sentence entry item 44. The user can associate the image data 2 with the sentence 36 which are displayed as the slide show in FIG. 12 by inputting the sentence to the sentence entry item 44 using the recommended dictionary window 39, the user dictionary window 40, or the ANK key 123g. Accordingly, when the user gives the photo album controller 1 in which the slide show is set up in advance to a family or friend as a gift, the user can also give an original message made up of the image data 2 and the sentence 36 as a gift in addition to the photo album controller 1 itself as a hardware.

As described above, in the present preferred embodiment, the remote controller 12 includes the first operation key group 121, the second operation key group 122, and the third operation key group 123 as the three button groups having different difficulty levels of the operation. Accordingly, the user can achieve the desired operation by using the operable button group. Moreover, when the folder name of the folder 33 is provided by the user, the photo album controller 1 displays this folder name on the attribute information display screen 5. The photo album controller 1 displays the shooting date of the predetermined image data 2 using the letters of “year”, “month”, or “day” on the attribute information display screen 5. Accordingly, the user can watch the high-quality image data 2 while visually recognizing the folder name which is changed by the user or the shooting date, so that the user can easily acknowledge the shooting status and time of the image data 2.

Moreover, when the folder names of the plural folders 33 stored in the physically-different memory cards 6a to 8a are identical with each other, the photo album controller 1 treats the plural folders 33 as logically one folder 33. Accordingly, the user can easily handle the folders. Furthermore, the photo album controller 1 enables the user to watch not only the image data 2 and the attribute information 5 simply but also a detailed status and feedback, for example, when the image data 2 is taken as the sentence 36 by setting up the slide show using the third operation key group 123.

The present invention is not limited to the configuration of the above preferred embodiment, however, various modification are applicable within the scope of the invention, so that the CPU 15 can also have a configuration to handle the shooting date and time of the image data 2 instead of the shooting date of the image data 2. For example, the attribute information display screen 5 can also display the shooting date and time by using the letters of “year”, “month”, “day”, “time”, “minute”, or “second” instead of using the letters of “year”, “month”, or “day” as the attribute information 4. When a positional information is provided to the image data 2 by the Exif function, the CPU 15 can also have a configuration to change the positional information to be expressed by “north latitude”, “south latitude”, “east longitude”, “west longitude”, or “degree” and associate it with the image data 2. Moreover, the attribute information display screen 5 can also have a configuration to display the positional information by using “north latitude”, “south latitude”, “east longitude”, “west longitude”, or “degree” as the attribute information 4. Furthermore, the attribute information display screen 5 can also have a configuration to scroll the attribute information 4 right to left in relation to the user for display, for example, instead of displaying the attribute information 4 which remains still.

What is claimed is:

1. A photo album controller which includes a display means by which an image data is displayed, an input means by which a user inputs a character information or an operating instruction, a controller which controls a whole apparatus, and a main memory unit which records a control program to control the whole apparatus, wherein
a memory card slot into which a memory card, which records the image data, is inserted is provided,
the input means can be detached from the photo album controller, has a power button to control a power supply to the photo album controller, and has a wired or wireless communication with the photo album controller,
the display means has a first display screen to display the image data and a second display screen to display a folder name of a folder stored in the memory card or a shooting date and time provided to the image data as attribute information,
the controller determines whether or not the folder name which is provided to the predetermined folder stored in the memory card corresponds to a format which is provided by Exif (Exchangeable image file format) function when the memory card is inserted into the memory card slot,
when determining that the format of the folder name does not correspond to the format provided by the Exif function, the controller displays the folder name on the second display screen and also displays the predetermined image data stored in the predetermined folder on the first display screen,
when determining that the format of the folder name corresponds to the format provided by the Exif function, the controller determines whether or not the shooting date and time provided to the predetermined image data which is stored in the predetermined folder corresponds to the format provided by the Exif function,
when determining that the format of the shooting date and time does not correspond to the format provided by the Exif function, the controller displays the shooting date and time on the second display screen and also displays the predetermined image data on the first display screen, and
when determining that the format of the shooting date and time corresponds to the format provided by the Exif function, the controller converts the shooting date and time into a display using letters of “year”, “month”, “day”, “time”, “minute”, or “second”, provides the converted shooting date and time to the predetermined image data as a new shooting date and time, displays the new shooting date and time on the second display screen, and displays the predetermined image data on the first display screen.

2. The photo album controller according to claim 1, wherein
upon a press of the power button during the display of the predetermined image data on the first display screen and the display of the attribute information on the second display screen, the controller firstly makes the main memory associate the image data with the attribute information and record them as a final display state, secondly stops a power supply to the photo album controller, and subsequently, when the power supply to the photo album controller starts by the press of the power button again, the controller displays the image data and the attribute information on the first display screen and the second display screen in accordance with the final display state.

3. The photo album controller according to claim 1, wherein
the input means further includes an arrow key, an ANK (Alphabet Numeric Kana) key, a function key, or a numeric key to input a letter and an operating instruction to the photo album controller,
the first display screen displays a folder name change screen for changing the folder name or a comment entry screen for the user inputting the arbitrary comment and for associating the comment with the image data in response to the input of the operating instruction via the input means,
when the first display screen displays the folder name change screen, the controller changes the folder name in response to the input of the letter or the operating instruction via the input means and then makes the memory card record the changed folder name as a new folder name, and
when the first display screen display the comment entry screen, the controller associates the inputted comment with the image data and makes the memory card record them as a slide show in response to the input of the letter or the operating instruction via the input means.

4. The photo album controller according to claim 2, wherein
the input means further includes an arrow key, an ANK (Alphabet Numeric Kana) key, a function key, or a numeric key to input a letter and an operating instruction to the photo album controller,
the first display screen displays a folder name change screen for changing the folder name or a comment entry screen for the user inputting the arbitrary comment and for associating the comment with the image data in response to the input of the operating instruction via the input means,
when the first display screen displays the folder name change screen, the controller changes the folder name in response to the input of the letter or the operating instruction via the input means and then makes the memory card record the changed folder name as a new folder name, and
when the first display screen display the comment entry screen, the controller associates the inputted comment with the image data and makes the memory card record them as a slide show in response to the input of the letter or the operating instruction via the input means.

5. The photo album controller according to claim 1:
wherein
the input means further includes an image album auto play button for regenerating an image album and a slide show auto play button for regenerating the slide show,
the controller displays all folder names stored in the memory card on the first display screen in response to the press of the image album auto play button and further selects the folder name according to how many times the image album auto play button is pressed and subsequently, the controller displays the image data stored in the folder to which the selected folder name is provided sequentially in a regular interval in accordance with a condition that the image album auto play button is not pressed in a predetermined period of time, and
the controller also displays the comment and the image data associated and recorded in the memory card simultaneously on the first display screen in response to the press of the slide show auto play button.

6. The photo album controller according to claim 2, wherein
the input means further includes an image album auto play button for regenerating an image album and a slide show auto play button for regenerating the slide show,
the controller displays all folder names stored in the memory card on the first display screen in response to the press of the image album auto play button and further selects the folder name according to how many times the image album auto play button is pressed and subsequently, the controller displays the image data stored in the folder to which the selected folder name is provided sequentially in a regular interval in accordance with a condition that the image album auto play button is not pressed in a predetermined period of time, and
the controller also displays the comment and the image data associated and recorded in the memory card simultaneously on the first display screen in response to the press of the slide show auto play button.

7. The photo album controller according to claim 3, wherein
the input means further includes an image album auto play button for regenerating an image album and a slide show auto play button for regenerating the slide show,
the controller displays all folder names stored in the memory card on the first display screen in response to the press of the image album auto play button and further selects the folder name according to how many times the image album auto play button is pressed and subsequently, the controller displays the image data stored in the folder to which the selected folder name is provided sequentially in a regular interval in accordance with a condition that the image album auto play button is not pressed in a predetermined period of time, and
the controller also displays the comment and the image data associated and recorded in the memory card simultaneously on the first display screen in response to the press of the slide show auto play button.

8. The photo album controller according to claim 4, wherein
the input means further includes an image album auto play button for regenerating an image album and a slide show auto play button for regenerating the slide show,
the controller displays all folder names stored in the memory card on the first display screen in response to the press of the image album auto play button and further selects the folder name according to how many times the image album auto play button is pressed and subsequently, the controller displays the image data stored in the folder to which the selected folder name is provided sequentially in a regular interval in accordance with a condition that the image album auto play button is not pressed in a predetermined period of time, and
the controller also displays the comment and the image data associated and recorded in the memory card simultaneously on the first display screen in response to the press of the slide show auto play button.

9. The photo album controller according to claim 1 further comprising:
a first memory card slot and a second memory card slot, wherein
in case that a folder name of a first folder stored in a first memory card is identical with a folder name of a second folder stored in a second memory card when the first and second memory cards are inserted into the first and second memory card slot, respectively, the controller determines the first folder and the second folder to be logically one folder and controls the first folder, the second folder, the image data stored in the first folder, and the image data stored in the second folder.

10. The photo album controller according to claim 2 further comprising:
a first memory card slot and a second memory card slot, wherein
in case that a folder name of a first folder stored in a first memory card is identical with a folder name of a second folder stored in a second memory card when the first and second memory cards are inserted into the first and second memory card slot, respectively, the controller determines the first folder and the second folder to be logically one folder and controls the first folder, the second folder, the image data stored in the first folder, and the image data stored in the second folder.

11. The photo album controller according to claim 3 further comprising:
a first memory card slot and a second memory card slot, wherein
in case that a folder name of a first folder stored in a first memory card is identical with a folder name of a second folder stored in a second memory card when the first and second memory cards are inserted into the first and second memory card slot, respectively, the controller determines the first folder and the second folder to be logically one folder and controls the first folder, the second folder, the image data stored in the first folder, and the image data stored in the second folder.

12. The photo album controller according to claim 4 further comprising:
a first memory card slot and a second memory card slot, wherein
in case that a folder name of a first folder stored in a first memory card is identical with a folder name of a second folder stored in a second memory card when the first and second memory cards are inserted into the first and second memory card slot, respectively, the controller determines the first folder and the second folder to be logically one folder and controls the first folder, the second folder, the image data stored in the first folder, and the image data stored in the second folder.

13. The photo album controller according to claim 5 further comprising:
a first memory card slot and a second memory card slot, wherein
in case that a folder name of a first folder stored in a first memory card is identical with a folder name of a second folder stored in a second memory card when the first and second memory cards are inserted into the first and second memory card slot, respectively, the controller determines the first folder and the second folder to be logically one folder and controls the first folder, the second folder, the image data stored in the first folder, and the image data stored in the second folder.

14. The photo album controller according to claim 6 further comprising:
a first memory card slot and a second memory card slot, wherein
in case that a folder name of a first folder stored in a first memory card is identical with a folder name of a second folder stored in a second memory card when the first and second memory cards are inserted into the first and second memory card slot, respectively, the controller determines the first folder and the second folder to be logically one folder and controls the first folder, the second folder, the image data stored in the first folder, and the image data stored in the second folder.

15. The photo album controller according to claim 7 further comprising:
a first memory card slot and a second memory card slot, wherein
in case that a folder name of a first folder stored in a first memory card is identical with a folder name of a second folder stored in a second memory card when the first and second memory cards are inserted into the first and second memory card slot, respectively, the controller determines the first folder and the second folder to be logically one folder and controls the first folder, the second folder, the image data stored in the first folder, and the image data stored in the second folder.

16. The photo album controller according to claim 8 further comprising:
a first memory card slot and a second memory card slot, wherein
in case that a folder name of a first folder stored in a first memory card is identical with a folder name of a second folder stored in a second memory card when the first and second memory cards are inserted into the first and second memory card slot, respectively, the controller determines the first folder and the second folder to be logically one folder and controls the first folder, the second folder, the image data stored in the first folder, and the image data stored in the second folder.
